(19) United States
(12) Patent Application Publication
(10) Pub. No.: US 2022/0045521 A1
(43) Pub. Date: Feb. 10, 2022

(54) METHOD AND APPARATUS FOR ACTIVE CURRENT BALANCING IN MULTIPLE PARALLEL BATTERY CELLS

(71) Applicant: Apple Inc., Cupertino, CA (US)

(72) Inventors: Robert J. HOYT, San Jose, CA (US); Todd D. HEATHERSHAW, San Jose, CA (US)

(73) Assignee: Apple Inc., Cupertino, CA (US)

(21) Appl. No.: 16/987,125

(22) Filed: Aug. 6, 2020

(51) Int. Cl. H02J 7/00

(52) U.S. Cl. CPC H02J 7/0014; H02J 7/0047

(57) ABSTRACT

Methods and apparatuses are disclosed for controlling charging power supplied to one or more parallel-connected rechargeable batteries. In the charging path of each battery, a current sensor and a current controller are disposed. The current sensor detects an amount of current being provided to the battery during charging, and provides this information to a system controller. The system controller receives the sensed current, and compares the current to an acceptable charge current range associated with the battery. If the charging current is determined to be within the acceptable range, then no changes are made to the current controller. If, on the other hand, the charging current is determined to be outside the acceptable range, then the system controller controls the current controller to adjust the amount of current provided to the battery.

### FIELD

Various embodiments generally may relate to the field of batteries, and battery charging.

### SUMMARY

In an embodiment of the present disclosure, a battery charging system is provided that includes a first battery subsystem and a second battery subsystem. The first battery subsystem includes a first battery and a first current control device coupled to an input terminal of the first battery and configured to control a first input current supplied to the first battery. The second battery subsystem includes a second battery and a second current control device coupled to an input terminal of the second battery and configured to control a second input current supplied to the second battery. The battery charging system further includes a control system configured to control the first current control device based on the first input current and control the second current control device based on the second input current.

In an embodiment of the present disclosure, a battery charging system is disclosed that includes a charging current source, a battery having a charging terminal connected to the charging current source via an input path, a current sensor disposed in the input path between a charging terminal of the battery and the charging current source, a current controller disposed in the input path between the current sensor and the charging current source, and a system controller. The system controller is configured to receive a sensed current from the current sensor, determine an adjustment voltage based on the sensed current, and transmit the adjustment to the current controller.

In an embodiment of the present disclosure, a method is disclosed for controlling charging current supplied to a first battery by a first current controller and a second battery by a second current controller. The method includes receiving a first sensed current value corresponding to a first current supplied to the first battery, receiving the second sensed current value corresponding to a second current supplied to the second battery, first comparing the first sensed current value to a first current range associated with the first battery, second comparing the second sensed current value to a second current range associated with the second battery, supplying a first control voltage to the first current controller based on the first comparing, and supplying a second control voltage to the second current controller based on the second comparing.

In embodiments, the first battery and the second battery are connected in parallel.

In embodiments, the first battery subsystem further includes a first current sensor configured to sense the first input current, and the second battery subsystem further includes a second current sensor configured to sense the second input current.

In embodiments, the first current sensor is configured to notify the control system of the sensed first input current, and the second current sensor is configured to notify the control system of the sensed second input current.

In embodiments, each of the first current sensor and the second current sensor include a resistor coupled to an operational amplifier.

In embodiments, the first and second current control devices are MOSFETs.

In embodiments, the control system is further configured to first compare the first input current to a current range associated with the first battery, output a control voltage to a gate of the MOSFET associated with the first current control device based on the first comparing, second compare the second input current to a current range associated with the second battery; and output a control voltage to a gate of the MOSFET associated with the second current control device based on the second comparing.

In embodiments, the control system includes a fault state input, and the control system is configured to turn off the first current control device and the second current control device in response to the fault state input identifying a fault state.

In embodiments, the current controller is configured to receive the adjustment from the system controller and adjust an amount of current provided to the charging terminal of the battery based on the received adjustment.

In embodiments, the adjustment is an adjustment is a voltage value.

In embodiments, the current sensor includes a resistor and an operational amplifier.

In embodiments, the operational amplifier measures a voltage differential across the resistor.

In embodiments, the battery charging system further includes a converter configured to digitize the measured voltage differential and convert the voltage differential to a current value corresponding to the sensed current.

In embodiments, the system controller includes a fault state input, and the system controller is configured to transmit an adjustment voltage to deactivate the current controller in response to detecting a fault state from the fault state input.

In embodiments, the first battery and the second battery are connected in parallel.

In embodiments, each of the first current controller and the second current controller is a MOSFET.

In embodiments, the first control voltage is supplied to a gate of the MOSFET associated with the first current controller, and the second control voltage is supplied to a gate of the MOSFET associated with the second current controller.

In embodiments, the method further includes sensing the first sensed current by measuring a first voltage differential across a first resistor, and sensing the second sensed current by measuring a second voltage differential across a second resistor.

In embodiments, the method further includes digitizing the first voltage differential across the first resistor, calculating the first sensed current based on the digitized first voltage differential, digitizing the second voltage differential across the second resistor, and calculating the second sensed current based on the digitized second voltage differential.

In embodiments, the method further includes detecting a charging fault state, and deactivating the first current controller and the second current controller in response to the detecting.

### BRIEF DESCRIPTION OF THE FIGURES

FIG. 1 illustrates a block diagram of an exemplary battery charging environment according to an embodiment;

FIG. 2 illustrates an exemplary circuit diagram of a battery charging system according to an embodiment;

FIG. 3 illustrates a flowchart diagram of an exemplary method for charging a battery according to an embodiment;

FIG. 4 illustrates a flowchart diagram of an exemplary current control method according to an embodiment; and

FIG. 5 illustrates a exemplary generic computer system capable of implementing certain aspects of the present disclosure.

### DETAILED DESCRIPTION

Mobile and portable devices have become prevalent throughout society. And those device are becoming increasingly more complex and powerful. With these new capabilities, today's mobile and portable devices increasingly depend on the capabilities of their batteries. In order to increase battery capabilities, many devices are outfitted with multiple batteries. These batteries are often connected in parallel and are charged from a single input current or voltage source. However, the batteries often have different sizes, capacities, impedances, etc., to fit within a desired form factor. As a result, the batteries can charge at different rates. This can be particularly detrimental to the batteries when the charging rate exceeds an acceptable charging rate rating for the battery. Additionally, the disparate characteristics of the batteries may result in one of the batteries being overcharged, while another is undercharged.

As disclosed in further detail below, a battery charging system according to embodiments of the present disclosure includes a sensor and a current controller disposed in a charging current path of each of the batteries. The sensors detect the charging current being provided to their corresponding batteries and report that information to a system controller. The system controller determines whether the current is within an acceptable predetermined range for the given battery, and transmits control signals to the current controllers to adjust that charging current. These, and other aspects of the present disclosure, are described herein with respect to the figures.

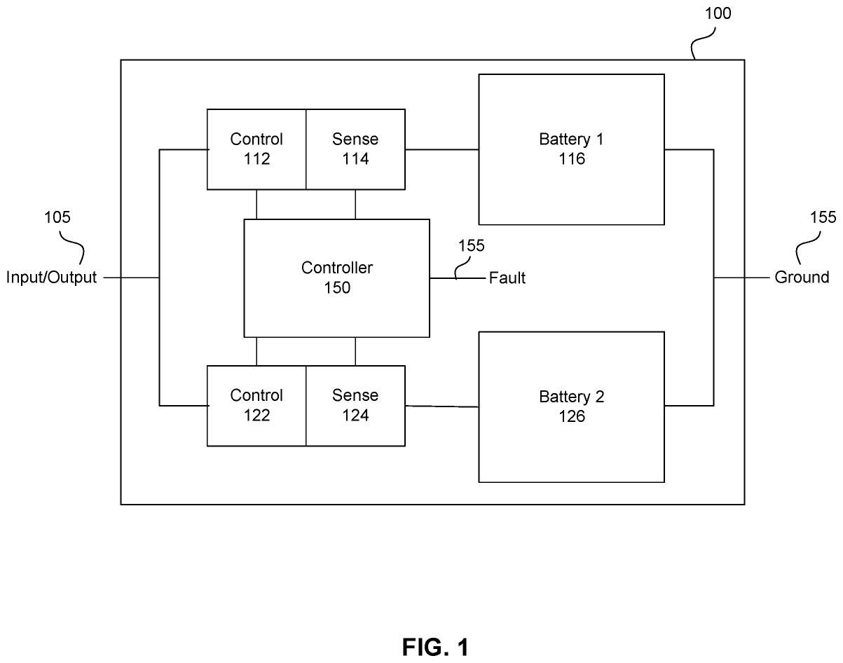

FIG. 1 illustrates a block diagram of an exemplary battery charging system 100 according to an embodiment. As shown in FIG. 1, a first battery 116 and a second battery 126 are connected in parallel. Each of the batteries 116 and 126 are connected to a common charging input/output 105 and a common ground 155. Disposed in the input path of the first battery 116 is a current controller 112 and a current sensor 114. Likewise, a current controller 122 and a current sensor 124 are disposed in the input path of the second battery 126.

A controller 150 communicates with the current controllers 112/122 and the current sensors 114, and carries out current control based on the information received from those elements. Specifically, the controller 150 receives a sensed input current for the first battery 116 from the current sensor 114. The controller 150 carries out multiple operations to determine whether the current being supplied to the first battery 116 is within an acceptable range. Based on this determination, the controller 150 sends control signals to the current controller 112. The current controller 112 adjusts an amount of current provided to the battery 116 based on the received control signals.

Similarly, controller 150 also receives a sensed input current for the second battery 126 from the current sensor 124. The controller 150 carries out multiple operations to determine whether the current being supplied to the second battery 126 is within an acceptable range. Based on this determination, the controller 150 sends control signals to the current controller 122. The current controller 122 then adjusts an amount of current provided to the battery 126 based on the received control signals.

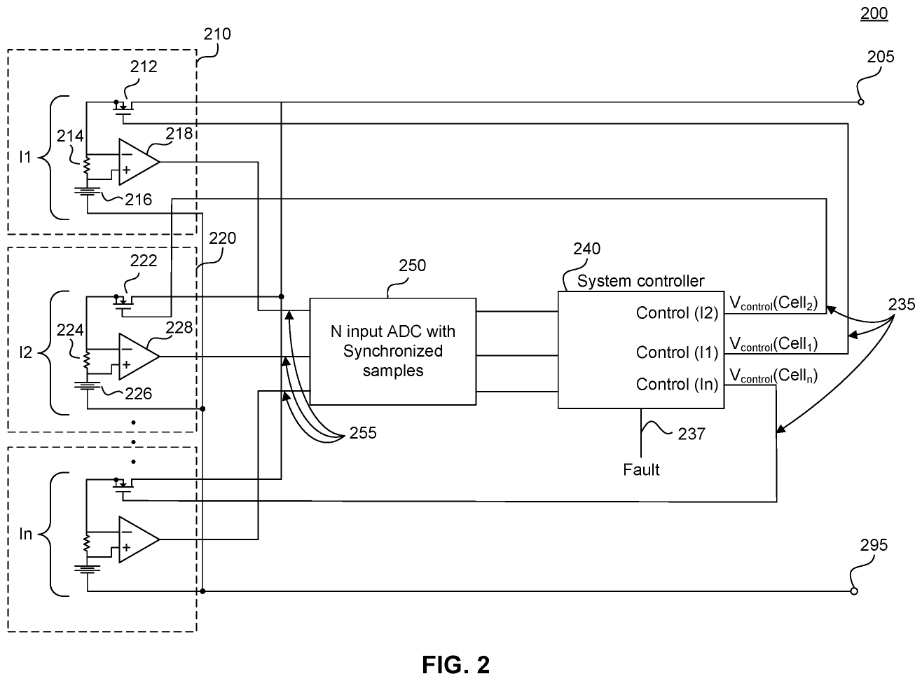

In embodiments, the controller 150 also receives a fault input 155. When a charging fault is detected, a fault signal is transmitted to the controller 150 via the fault input 155. In response, the controller 150 takes a predefined fault control action. In an embodiment, this fault control action includes instructing the current controllers 112/114 to turn off charging current. The functionality and configurations of the controller 150, current controllers 112/122 and current sensors 114/124 will be described in further detail below with respect to FIG. 2.

FIG. 2 illustrates an exemplary circuit diagram of a battery charging system according to an embodiment. The circuit of FIG. 2 includes multiple batteries 216, 226 connected in parallel. Each of the batteries 216, 226 is associated with a corresponding current control circuit 210, 220. These current control circuits provide sensed current information to a system controller 240 via an analog-to-digital converter 250. The system controller 240 carries out analyses of the received signals, and outputs control signals to the current control circuits 210, 220 to individually adjust the respective currents provided to the batteries 216, 218. As shown in FIG. 2, this configuration is scalable. Specifically, the number of batteries and current control circuits can be duplicated any number of times. The circuit 200 is then modified to provide n inputs from each of the current control circuits to the system controller 240, and to provide n outputs from the system controller 240 to the various current control circuits.

The specific configuration illustrated in FIG. 2 will now be described with respect to the two current control circuits 210, 220. As shown in FIG. 2, the circuits 210-220 receive input charging current from an input terminal 205. This current is distributed to each of the current control circuits 210, 220.

Current control circuit 210 includes a current controller 212 and a sensor 214 connected in series between the battery 216 and the input current 205. In an embodiment, the current controller 212 is a transistor. In a further embodiment, the transistor is a metal oxide semiconductor field effect transistor (MOSFET). In an embodiment, the sensor 214 is a resistor. An operational amplifier (op-amp) 218 is connected to opposite terminals of the sensor 214. With this configuration, the op-amp 218 detects a voltage differential across the sensor 214, which is representative of the charging current value being received by battery 216.

The output of the op-amp 218 is connected to the analog-to-digital converter (ADC) 250, such that the detected voltage differential is provided to the ADC 250. The ADC 250 digitizes the voltage value and provides the digitized voltage to the system controller 240. In an embodiment, the ADC 250 and system controller 240 together correspond to the controller 150 of FIG. 1.

In embodiments, the system controller 240 is programmed with relevant information necessary to carry out its analysis of the received voltage. For example, the system controller may be programmed with the specific resistance values of the sensors 214, 224 and the charge current ranges of the batteries 216, 226. In another embodiment, this information is stored in a separate memory that is accessed by the system controller 240.

Upon receipt of the sensed voltage information from the op-amp 218 and the ADC 250, the system controller first converts the voltage value to a current value using Ohm's law (V=IR). Specifically, the system controller 240 divides the received voltage value by the known resistance of the sensor 214. This provides a current value indicative of the amount of charging current being received by the battery 216.

The system controller 240 then compares the calculated current value to an acceptable charge current range associated with the battery 216. In particular, the system controller 240 examines whether the charging current is within the acceptable charge current range, i.e., whether Iₘᵢₙ≤I₁≤Iₘₐₓ. In an embodiment, if the charging current is determined to be outside the acceptable charging current range, then the system controller 240 modifies a control signal (V_{control}(Cell₁)) that is provided to the current controller 212. In the embodiment in which the current controller is a MOSFET, the control signal is a gate voltage that controls the conductance of the MOSFET while operating in the linear range. For example, when the sensed current is determined to be lower than the acceptable range (e.g., I₁<Iₘᵢₙ), the system controller 240 increases the gate voltage in order to increase the conductivity of the channel of the MOSFET, thereby allowing more current to flow to the battery 216. Conversely, when the sensed current is determined to be higher than the acceptable range (e.g., I₁>Iₘₐₓ), the system controller 240 decreases the gate voltage in order to decrease the conductivity of the channel of the MOSFET, thereby reducing the amount of current that flows to the battery 216.

In other embodiments, the system controller 240 can adjust the gate voltage even when the sensed current is within the acceptable range. This can occur so as to bring the current closer to a median acceptable charging current (e.g., furthest from the both the Iₘᵢₙ and Iₘₐₓ of the battery). This is useful for the keeping the battery at an “ideal” or “preferred” charging rate, and also reduces the chance that brief fluctuations in the charging rate will temporarily fall outside of the acceptable charging current range.

The circuit 200 operates similarly with respect to each of the other current control circuits. In an embodiment, the system controller 240 controls each of the current controllers 212, 222, independent of the others. In another embodiment, the system controller 240 controls each of the current controllers 212, 222 in consideration of the others. For example, adjusting the current provided to the first battery 216 may affect the current provided to other batteries, which can be calculated and accounted for by the system controller 240.

Additionally, in an embodiment, the system controller 240 includes a fault input 237. The fault input 237 provides the system controller 240 with a fault state indicator. When the fault input 237 is inactive, the system controller 240 functions normally as described above. However, when the fault input 237 is activated, the system controller 240 enters a fault state. In this state, the system controller 240 controls the control voltage to turn off the current controllers (e.g., stop all charging current supplied to the battery). For example, when current controllers 212, 222 are MOSFETS, an appropriate voltage can be selected for the control voltage to cutoff the respective MOSFETs, and stop the charging current to the respective batteries 216, 226. In an embodiment, the fault state indicator is battery-specific, in which case the system controller 240 only turns off the respective current controller associated with the battery experiencing the fault condition. In another embodiment, the fault state is generalized to the whole charging circuit 200, in which case the system controller 240 turns off all current controllers 212, 222, etc.

In this manner, the system controller together with the current control circuits 210, 220, etc., controls charging current supplied to the batteries 216, 226, etc. so as to maintain charging current within acceptable ranges for those batteries. This increases battery longevity and device lifespan.

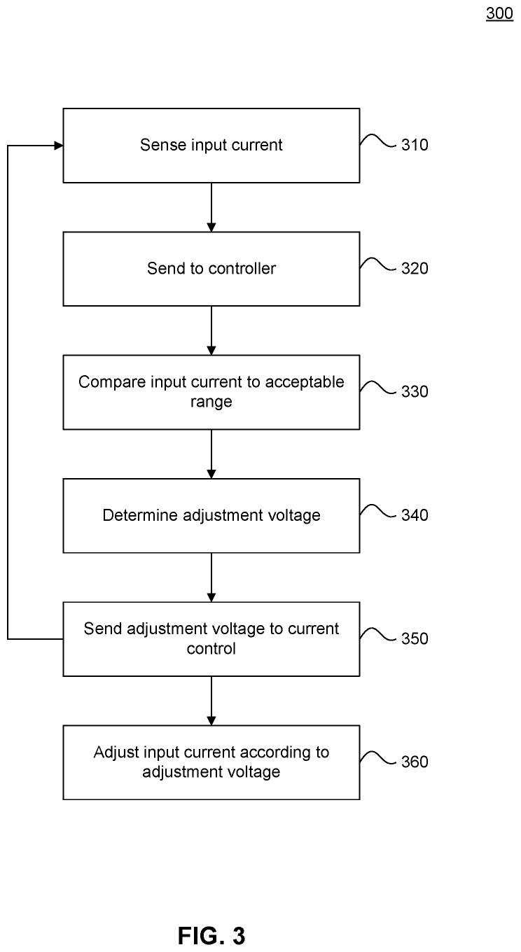

FIG. 3 illustrates a flowchart diagram of an exemplary method 300 for charging each battery of a number of batteries that are connected in parallel, according to an embodiment. As shown in FIG. 3, the method begins by the sensor sensing the input current (310) provided to the battery. In an embodiment, this “current” can be sensed in the form of a voltage differential across the sensor, provided that the resistance of the sensor over is known over which the voltage differential is measured. The sensor sends the current measurement (or voltage differential representative of the current measurement) to the controller (320). The controller receives the current measurement and compares it to an acceptable charging current range associated with the battery (330). In an embodiment, the acceptable charging current range is predetermined and preprogrammed into the controller. In other embodiments, this information is stored in memory separate from the controller.

If the controller determines that the current is within the acceptable range, then the controller makes no adjustment to the control voltage applied to current controller associated with a particular battery of the number of batteries. On the other hand, if the current is outside the acceptable range, then the controller determines an adjustment voltage (340) to be applied to the current controllers. In an embodiment, the controller is programmed with an adjustment table or adjustment formula for determining the appropriate voltage adjustment to be made based on the degree to the which the current requires adjusting in order to achieve a desired change in current. Based on these relationships, the controller determines the proper adjustment voltage.

The controller then sends the adjustment voltage (350) to the current controller. In an embodiment, the controller always maintains the voltage applied to the current controllers. Therefore, regardless of whether the current is deemed to be within the acceptable range, or outside the range, the controller sends a voltage to the current controller.

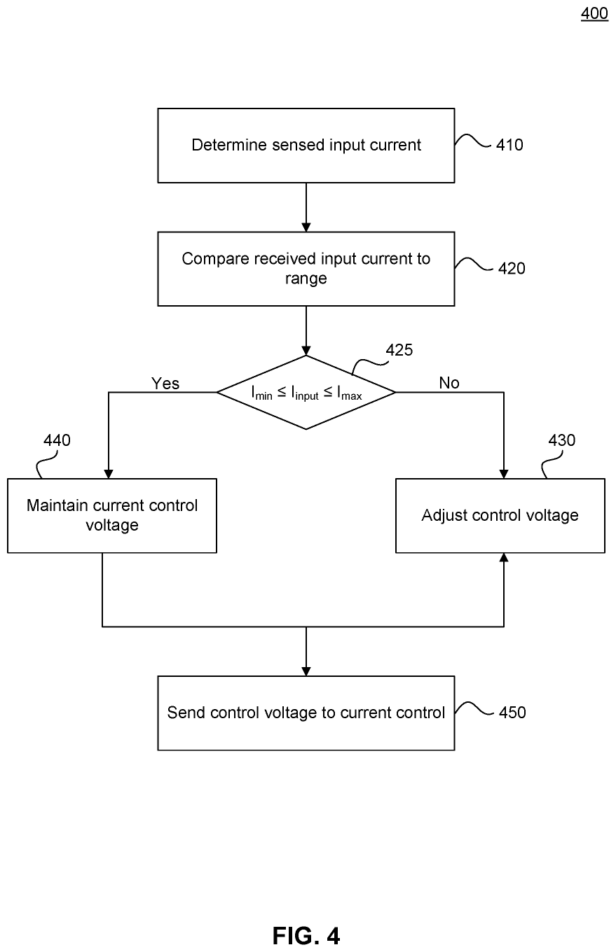

The current controller receives the adjustment voltage from the controller, and adjusts the current (360) according to the received adjustment voltage. In the embodiment of the current controller being a MOSFET, this is achieved by the adjustment voltage being applied to the gate of the MOSFET. This causes a corresponding adjustment in the conductivity of the MOSFET channel, and the current flow through that channel. In embodiments, this method may be supplemented or modified by the above disclosures. The specific functionality of the controller will now be described with respect to FIG. 4.

FIG. 4 illustrates a flowchart diagram of an exemplary current control method 400 according to an embodiment. As shown in FIG. 4, the system controller determines the sensed input currents (410) from one or more current sensors. The system controller then compares the received input currents to a corresponding acceptable range (420). In an embodiment, each battery is associated with its own specific acceptable charging current range, and the system controller compares the received sensed current values to the appropriate charging current ranges associated with their batteries. Specifically, for each battery, the system controller determines whether Iₘᵢₙ≤Iᵢₙₚᵤₜ≤Iₘₐₓ (425). If the input current Iᵢₙₚᵤₜ is within this range (425-Y), then the system controller maintains the control voltage at its current level (440). In some embodiments, this is achieved by maintaining a constant voltage on the control line provided to the current controller. In other embodiments, this is achieved by declining to transmit a new voltage adjustment signal to the current controller.

If, on the other hand, the input current Iᵢₙₚᵤₜ is outside this range, then the system controller determines an appropriate control voltage (430) to be applied to the current controller. As discussed above, in embodiments, the controller is programmed with an adjustment table or adjustment formula for determining the appropriate control voltage to be made based on the degree to the which the current requires adjusting. Based on these relationships, the system controller determines the proper adjustment voltage.

After the proper control voltage is determined, the system controller sends the control voltage to the current controller (450). In an embodiment where the current controller is a MOSFET, this is carried out by applying the control voltage to the gate of the MOSFET. In this manner, the system controller processes current values being applied to the batteries, and adjusts them appropriately in order to prevent the battery from being overcharged or undercharged. As a result, the lifespan of the batteries is increased, as is that of the device in which they are housed.

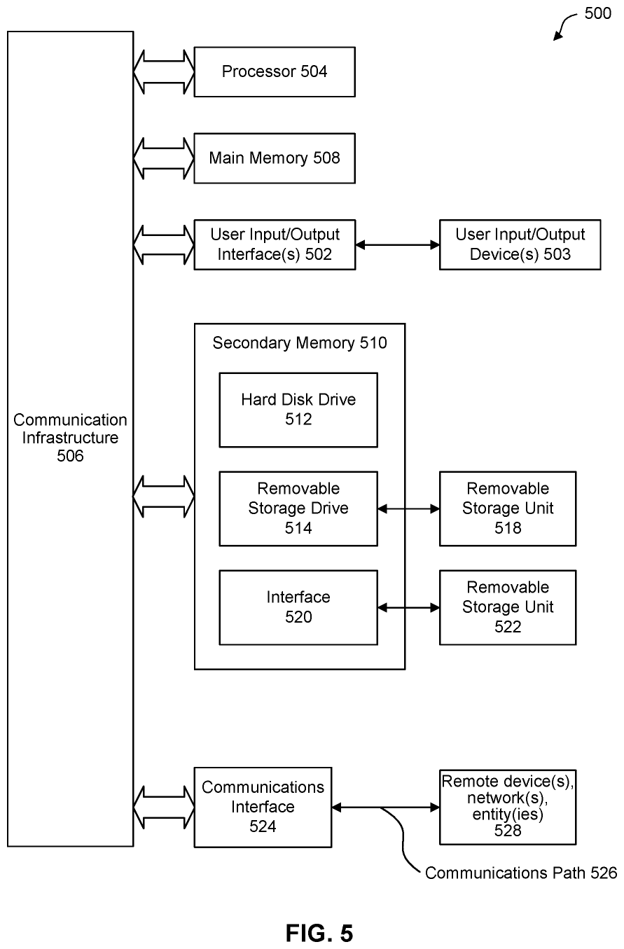

Various embodiments can be implemented, for example, using one or more computer systems, such as computer system 500 shown in FIG. 5. Computer system 500 can be any well-known computer capable of performing the functions described herein such as system controller 240 of FIG. 2. Computer system 500 includes one or more processors (also called central processing units, or CPUs), such as a processor 504. Processor 504 is connected to a communication infrastructure 506 (e.g., a bus.) Computer system 500 also includes user input/output device(s) 503, such as monitors, keyboards, pointing devices, etc., that communicate with communication infrastructure 506 through user input/output interface(s) 502. Computer system 500 also includes a main or primary memory 508, such as random access memory (RAM). Main memory 508 may include one or more levels of cache. Main memory 508 has stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/or any other computer data storage device. Removable storage drive 514 reads from and/or writes to removable storage unit 518 in a well-known manner.

According to some embodiments, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526.

The operations in the preceding embodiments can be implemented in a wide variety of configurations and architectures. Therefore, some or all of the operations in the preceding embodiments may be performed in hardware, in software or both. In some embodiments, a tangible, non-transitory apparatus or article of manufacture includes a tangible, non-transitory computer useable or readable medium having control logic (software) stored thereon is also referred to herein as a computer program product or program storage device. This includes, but is not limited to, computer system 500, main memory 508, secondary memory 510 and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use embodiments of the disclosure using data processing devices, computer systems and/or computer architectures other than that shown in FIG. 5. In particular, embodiments may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A battery charging system, comprising:
a first battery subsystem, including:
a first battery; and
a first current controller coupled to an input terminal of the first battery and configured to control a first input current supplied to the first battery;
a second battery subsystem, including:
a second battery; and
a second current controller is coupled to an input terminal of the second battery and configured to control a second input current supplied to the second battery; and
a system controller configured to control the first current controller based on the first input current and control the second current controller based on the second input current,
wherein the first battery and the second battery are connected in parallel.

2. The battery charging system of claim 1, wherein the first battery subsystem further includes a first current sensor configured to sense the first input current, and
wherein the second battery subsystem further includes a second current sensor configured to sense the second input current.

3. The battery charging system of claim 2, wherein each of the first current sensor and the second current sensor include a resistor coupled to an operational amplifier.

4. The battery charging system of claim 1, wherein the first current controller is a first MOSFET, and
wherein the second current controller is a second MOSFET.

5. The battery charging system of claim 4, wherein the system controller is further configured to:
first compare the first input current to a first current range associated with the first battery;
output a control voltage to a gate of the first MOSFET associated based on the first comparing;
second compare the second input current to a second current range associated with the second battery; and
output a control voltage to a gate of the second MOSFET based on the second comparing.

6. The battery charging system of claim 1, wherein the system controller includes a fault state input, and
wherein the system controller is configured to turn off the first current controller and the second current controller in response to the fault state input identifying a fault state.

7. A battery charging system, comprising:
a battery having a charging terminal connected to a charging current source via an input path;
a current sensor disposed in the input path between a charging terminal of the battery and the charging current source;
a current controller disposed in the input path between the current sensor and the charging current source; and
a system controller configured to:
receive a sensed current from the current sensor;
determine an adjustment voltage based on the sensed current; and
transmit the adjustment voltage to the current controller.

8. The battery charging system of claim 7, wherein the current controller is configured to receive the adjustment voltage from the system controller and adjust an amount of current provided to the charging terminal of the battery based on the received adjustment voltage.

9. The battery charging system of claim 8, wherein the current controller is a MOSFET, and
wherein the current controller receives the adjustment voltage at a gate of the MOSFET.

10. The battery charging system of claim 7, wherein the current sensor includes a resistor and an operational amplifier.

11. The battery charging system of claim 10, wherein the operational amplifier measures a voltage differential across the resistor.

12. The battery charging system of claim 11, further comprising a converter configured to digitize the measured voltage differential.

13. The battery charging system of claim 12, wherein the system controller is further configured to receive the digitized voltage differential from the converter, and to calculate the sensed current from the digitized voltage differential.

14. The battery charging system of claim 8, wherein the system controller includes a fault state input, and
wherein the system controller is configured to set the adjustment voltage to deactivate the current controller in response to detecting a fault state from the fault state input.

15. A method for controlling charging current supplied to a first battery by a first current controller and a second battery by a second current controller, the method comprising:
determining a first sensed current value corresponding to a first current supplied to the first battery, and a second sensed current value corresponding to a second current supplied to the second battery;
first comparing the first sensed current value to a first current range associated with the first battery;
second comparing the second sensed current value to a second current range associated with the second battery;
supplying a first control voltage to the first current controller based on the first comparing; and
supplying a second control voltage to the second current controller based on the second comparing.

16. The method of claim 15, wherein the first battery and the second battery are connected in parallel.

17. The method of claim 15, wherein each of the first current controller and the second current controller is a MOSFET.

18. The method of claim 17, wherein the first control voltage is supplied to a gate of the MOSFET associated with the first current controller, and
wherein the second control voltage is supplied to a gate of the MOSFET associated with the second current controller.

19. The method of claim 15, wherein the determining comprises:
sensing the first sensed current value by measuring a first voltage differential across a first resistor; and
sensing the second sensed current value by measuring a second voltage differential across a second resistor.

20. The method of claim 19, wherein the determining further comprises:
digitizing the first voltage differential across the first resistor;
calculating the first sensed current value based on the digitized first voltage differential;
digitizing the second voltage differential across the second resistor; and
calculating the second sensed current value based on the digitized second voltage differential.

21. The method of claim 15, further comprising:
detecting a charging fault state; and
deactivating the first current controller and the second current controller in response to the detecting.
